(19) United States
(12) Patent Application Publication
(10) Pub. No.: US 2009/0009497 A1
(43) Pub. Date: Jan. 8, 2009

(54) LIQUID CRYSTAL DISPLAY AND METHOD OF DRIVING THE SAME

(75) Inventors: Bong-jun LEE, Seoul (KR); Do-hyeon PARK, Cheonan-si (KR); Kye-hun LEE, Cheonan-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/147,738

(22) Filed: Jun. 27, 2008

(30) Foreign Application Priority Data
Jul. 6, 2007 (KR) 10-2007-0068213

(51) Int. Cl. G09G 5/00; G09G 3/36

(52) U.S. Cl. 345/205; 345/90

(57) ABSTRACT

A liquid crystal display includes a liquid crystal panel, which receives a plurality of gate signals and a plurality of data signals to display an image, a gate driver and a signal supplier which supplies a first scan-start signal, a clock signal and a clock bar signal to the gate driver, the clock bar signal having an inverse phase to that of the clock signal, wherein the clock signal includes a maintenance period and first and second transition periods, the maintenance period is defined when the clock signal is maintained at a first level, the first and second transition periods defined from a point when the clock signal transitions to a second level from the first level and to a subsequent point when the clock signal transitions to the first level from the second level, the first scan-start signal is maintained at the second level during the first transition period.

This application claims priority to Korean Patent Application No. 10-2007-0068213, filed on Jul. 6, 2007, and all the benefits accruing therefrom under 35 U.S.C § 119, the contents of which are herein incorporated by reference in its entirety.

### BACKGROUND OF THE INVENTION

1. Field of the Invention

The present invention relates to a liquid crystal display (“LCD”) and a method of driving the same, and more particularly, to an LCD with an improved display quality and a method of driving the same.

2. Description of the Related Art

LCDs generally include gate driving integrated circuits (“ICs”) which are mounted in the form of a tape carrier package (“TCP”), a chip-on-glass (“COG”), or other suitable mounting methods. In addition, several other methods have also been explored in order to improve manufacturing costs or a product size and design of the LCDs. Specifically, for example, gate driving ICs have been replaced with gate drivers, which generate gate signals using amorphous silicon thin film transistors (hereinafter, referred to as “a-Si TFTs”), that are mounted on glass substrates.

### BRIEF SUMMARY OF THE INVENTION

An exemplary embodiment of the present invention provides a liquid crystal display (“LCD”) with an improved display quality.

Another exemplary embodiment of the present invention provides a method of driving an LCD with an improved display quality.

However, alternative exemplary embodiments of the present invention are not limited to those mentioned herein, and other exemplary embodiments of present invention will be apparent to those of ordinary skill in the art through the following description.

An exemplary embodiment of the present invention discloses an LCD which includes a liquid crystal panel including a plurality of gate lines and a plurality of data lines, a gate driver which supplies the plurality of gate signals to the plurality of gate lines and a signal supplier. The signal supplier supplies a first scan-start signal, a clock signal and a clock bar signal to the gate driver, the clock bar signal having an inverse phase to that of the clock signal. The clock signal includes a maintenance period and a transition period. The maintenance period is defined when the clock signal is maintained at a first level. The transition periods are defined from a point when the clock signal transitions from the first level to a second level and to a subsequent point when the clock signal transitions from the second level to the first level. The first scan-start signal is maintained at the second level during the first transition period.

Another exemplary embodiment of the present invention discloses a method of driving an LCD, the method includes supplying a first scan-start signal, a clock signal and a clock bar signal to a gate driver which supplies a plurality of gate signals to a plurality of gate lines. The clock bar signal has an inverse phase to that of the clock signal. The clock signal includes a maintenance period and a first transition period. The maintenance period is defined when the clock signal is maintained at a first level. The transition period is defined from a point when the clock signal transitions from the first level to a second level and to a subsequent point when the clock signal transitions from the second level to the first level. The first scan-start signal is maintained at the second level during the first transition period. The gate driver is enabled by the first scan-start signal, generates a plurality of gate signals by using the clock signal and the clock bar signal and supplies the plurality of gate signals to the plurality of gate lines.

Other exemplary embodiments and variations are included in the description and drawings.

### BRIEF DESCRIPTION OF THE DRAWINGS

The above and other aspects, features and advantages of the present invention will become more apparent by describing in further detail exemplary embodiments thereof with reference to the attached drawings, in which:

FIG. 1 is a block diagram illustrating a liquid crystal display (“LCD”) and a method of driving the same according to embodiments of the present invention;

FIG. 2 is an equivalent schematic circuit diagram of a pixel of FIG. 1;

FIG. 3 is a block diagram of a gate driver of FIG. 1;

FIG. 4 is a schematic circuit diagram of a j-th stage of a gate driver of FIG. 3;

FIG. 5 is a signal waveform timing chart illustrating an operation of the j-th stage of FIG. 4;

FIG. 6 is a schematic circuit diagram of a first stage of a gate driver of FIG. 3;

FIG. 7 is a signal waveform timing chart illustrating an operation of the first stage of FIG. 6;

FIG. 8 is a signal waveform timing chart for explaining a liquid crystal display and a method of driving the same according to a first embodiment of a first embodiment of the present invention;

FIG. 9 is a block diagram for explaining a clock generator of a liquid crystal display according to the first embodiment of the present invention;

FIG. 10 is a signal waveform timing chart for explaining a liquid crystal display and a method of driving the same according to a second embodiment of the present invention; and

FIG. 11 is a block diagram for explaining a clock generator of a liquid crystal display according to the second embodiment of the present invention.

### DETAILED DESCRIPTION OF THE INVENTION

The invention is described more fully hereinafter with reference to the accompanying drawings, in which exemplary embodiments of the invention are shown. The present invention may, however, be embodied in many different forms and should not be construed as being limited to the exemplary embodiments set forth herein. Rather, these exemplary embodiments are provided so that this disclosure will be thorough and complete, and will fully convey the scope of the invention to those of ordinary skill in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Furthermore, a “first level” and a “second level” described in the claims are logic levels. The “first level” and the “second level” may be a low level and a high level, respectively or, conversely, the “first level” and the “second level” may be a high level and a low level, respectively. Hereinafter a case wherein the “first level” is a low level and the “second level” is a high level is described as an example. When both signals are the first level (or the second level), logic levels of both signals are the same, however voltage levels (e.g., an analog value) of the signals may be different.

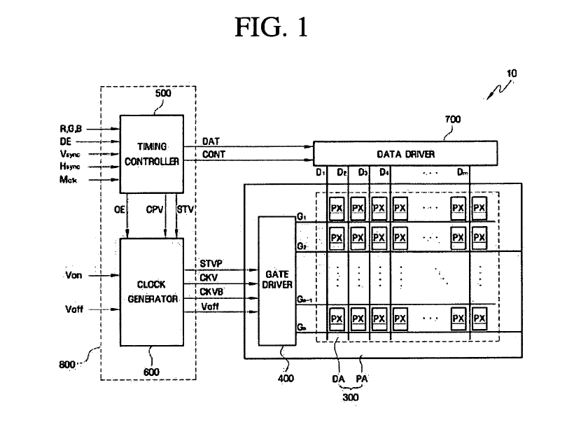

A liquid crystal display (“LCD”) and a method of driving the same according to embodiments of the present invention is described hereinafter in further detail with reference to FIGS. 1 through 7.

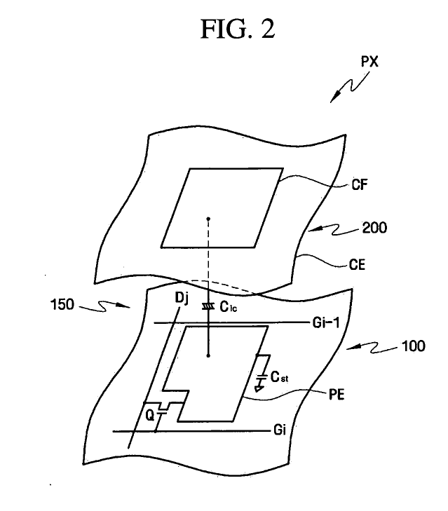

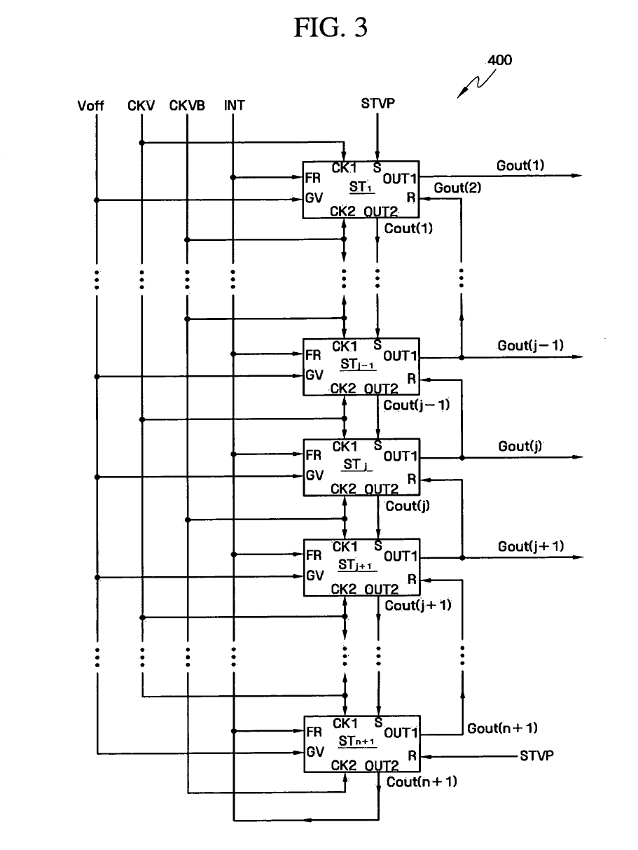

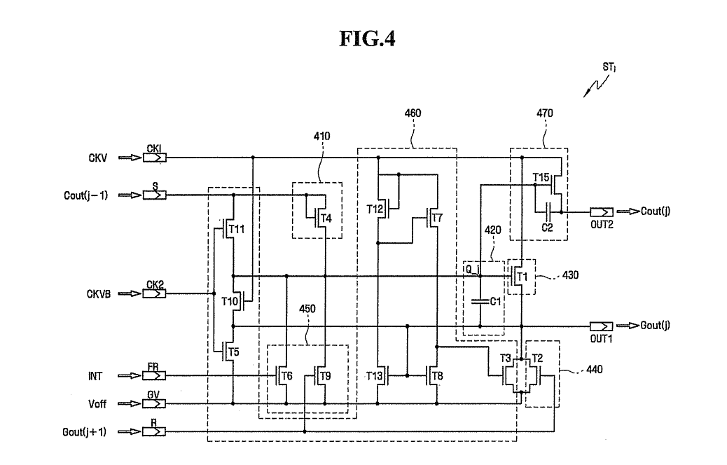

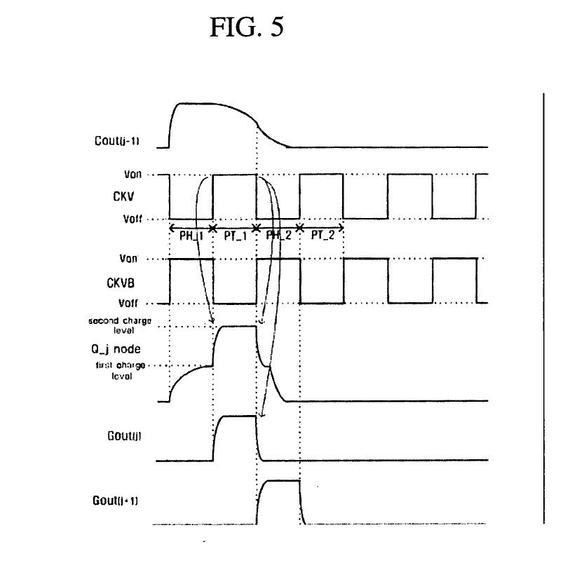

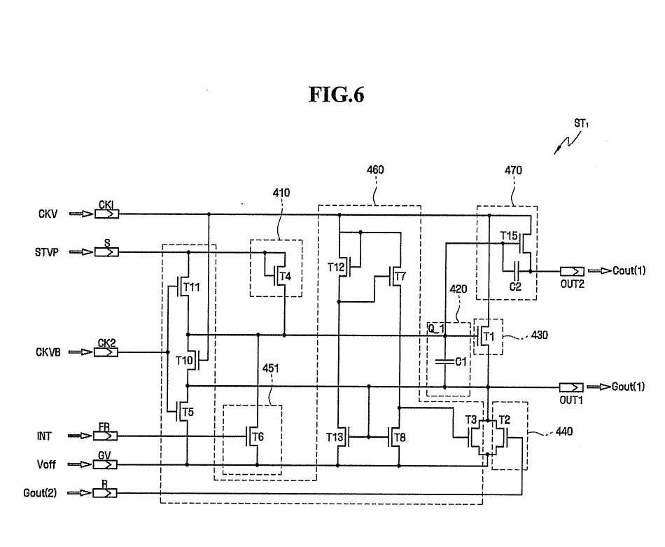

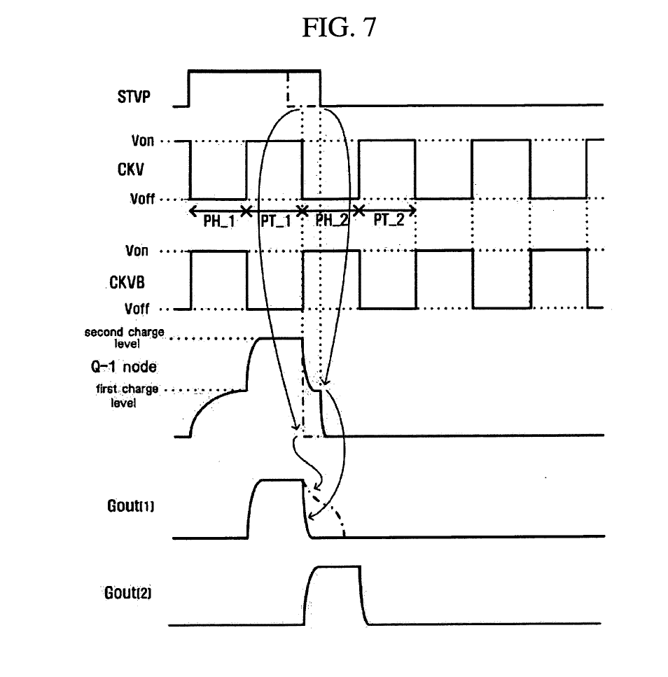

FIG. 1 is a block diagram illustrating a liquid crystal display (“LCD”) and a method of driving the same according to embodiments of the present invention. FIG. 2 is an equivalent schematic circuit diagram of a pixel of FIG. 1. FIG. 3 is a block diagram of a gate driver of FIG. 1. FIG. 4 is a schematic circuit diagram of a j-th stage of a gate driver of FIG. 3. FIG. 5 is a signal waveform timing chart illustrating an operation of the j-th stage of FIG. 4. FIG. 6 is a schematic circuit diagram of a first stage of a gate driver of FIG. 3. FIG. 7 is a signal waveform timing chart illustrating an operation of the first stage of FIG. 6.

Referring now to FIGS. 1 and 2, a liquid crystal display 10 according to embodiments of the present invention includes a liquid crystal panel 300, a signal supplier 800, a gate driver 400 and a data driver 700. The signal supplier 800 includes a timing controller 500 and a clock generator 600.

The liquid crystal panel 300 is divided into a display area DA, where an image is displayed, and a non-display area PA, where an image is not displayed.

The liquid crystal panel 300 includes a first substrate 100, which includes a plurality of gate lines G₁ to Gₙ, a plurality of data lines D₁ to Dₘ, switching elements Q and pixel electrodes PE formed thereon, a second substrate 200, which includes color filters CF and a common electrode CE formed thereon and a liquid crystal layer C_{1c} interposed between the first substrate 100 and the second substrate 200, such that an image is displayed within the display area DA. The gate lines G₁ to Gₙ extend in a first direction, such as a row direction, so as to be substantially in parallel with one another, and the data lines D₁ to Dₘ extend in a second direction, such as a column direction, so as to be substantially in parallel with one another. In exemplary embodiments, the first direction is substantially perpendicular to the second direction.

Referring to FIGS. 1 and 2, in exemplary embodiments, a pixel PX includes a color filter CF which may be formed on an area of the common electrode CE of the second substrate 200, such that the color filter CF is disposed to face the pixel electrode PE of the first substrate 100. In here, the pixel PX, which is connected to an i-th gate line Gᵢ (i=1 to n) and to a j-th data line Dⱼ (j=1 to m), includes the switching element Q, which is connected to a signal line Gi, Dj, and the liquid crystal capacitor C_{lc} and a storage capacitor Cst which are connected to the switching element Q. However, in exemplary embodiments, the storage capacitor Cst may be omitted. In further exemplary embodiments, the switching element Q may be a thin film transistor (“a-Si TFT”) made from amorphous silicon.

The first substrate 100 (see FIG. 2) is larger in size than the second substrate 200 (see FIG. 2), such that the non-display area PA does not display an image.

The signal supplier 800 includes the timing controller 500 and the clock generator 600. The signal supplier 800 receives input RGB image signals and an input-control signal and controls a display of an image from a graphic controller (not shown), and the signal supplier 800 supplies an image signal DAT and a data control signal CONT to the data driver 700. Specifically, in exemplary embodiments, the timing controller 500 receives the input control signal which includes, for example, a horizontal sync signal Hsync, a main clock signal Mclk and a data enable signal DE. And the timing controller 500 supplies the data control signal CONT to the data driver 700. In exemplary embodiments, the data control signal CONT controls an operation of the data driver 700. The data control signal CONT includes, for example, a horizontal start signal for starting an operation of data driver 700 and a load signal for instructing an output of two data voltages. However, the present invention is not limited thereto.

The data driver 700 receives the image signal DAT and the data control signal CONT, and the data driver 700 supplies an image data voltage corresponding to the image signal DAT to the lines D₁ to Dₘ. The data driver 700 is an integrated circuit (“IC”), and is connected to the liquid crystal panel 300 in a tape carrier package (“TCP”) manner, however, the present invention is not limited thereto. In exemplary embodiments, the data driver 700 may be formed on the non-display area PA of the liquid crystal panel 300.

Furthermore, the signal supplier 800 receives a vertical sync signal Vsync and the main clock signal Mclk from the graphics controller (not shown), which is located externally to the signal supplier 800. The signal supplier 800 receives a gate-on voltage Von and a gate-off voltage Voff from a voltage generator (not shown), and the signal supplier 800 supplies a first scan-start signal STVP, a clock signal CKV, a clock bar signal CKVB and the gate-off voltage Voff to the gate driver 400. Specifically, the timing controller 500 supplies a second scan-start signal STV, a first clock-generation-control signal OE and a second clock-generation-control signal CPV to a clock generator 600. The clock generator 600 receives the second scan-start signal STV, and outputs the first scan start STVP to the gate driver 400. Furthermore, the clock generator 600 receives the first clock-generation-control signal OE and the second clock-generation-control signal CPV, and the clock generator 600 supplies the clock signal CKV and the clock bar signal CKVB to the gate driver 400. In here, the clock signal CKV is an inverse-phase signal of the clock bar signal CKVB.

The clock generator 600 is described later in more detail in accordance with exemplary embodiments of the present invention.

The gate driver 400 is enabled by the first scan start STVP received from the clock generator 600. The gate driver 400 generates a plurality of gate signals using the clock signal CKV, the clock bar signal CKVB and the gate-off voltage Voff., The gate driver 400 sequentially supplies a gate signal of the plurality of gate signals to each gate line G₁ to Gₙ, respectively. The gate driver 400 is now described in more detail with reference to FIG. 3.

The gate driver 400 includes a plurality of stages ST₁ to STₙ₊₁, which are connected to one another in a cascade manner, as illustrated in FIG. 3. Each of the stages ST₁ to STₙ, except for the final stage STₙ₊₁, is connected to a respective corresponding gate line of the plurality of gate lines G₁ to Gₙ, and the stages ST₁ to STₙ output gate signals Gout(1) to Gout(n), respectively. Each of the stages ST₁ to STₙ₊₁ receives the gate-off voltage Voff, the clock signal CKV, the clock bar signal CKVB and an initializing signal INT. In here, the initializing signal INT may be supplied by the clock generator 600. However, the present invention is not limited thereto.

In exemplary embodiments, each of the stages ST₁ to STₙ₊₁ may include a first clock terminal CK1, a second clock terminal CK2, a set terminal S, a reset terminal R, a power-supply-voltage terminal GV, a frame-rest-terminal FR, a gate-output terminal OUT1 and a carry output terminal OUT2.

Specifically, and for purposes of further illustration, among the stages ST₁ to STₙ₊₁, a j-th stage STⱼ, for example, includes a set terminal S to which a carry signal Cout(j−1) of a previous stage STⱼ₋₁ is input, a reset terminal R to which a gate signal Gout(j+1) of a next stage STⱼ₊₁ is input, a first clock terminal CK1 and a second clock terminal CK2 to which the first clock signal CKV and the clock bar signal CKVB are input, respectively, the power-supply voltage terminal GV to which the gate-off voltage Voff is input and the frame-reset-terminal FR to which the initializing signal INT or the carry signal Cout(n+1) of a last stage STₙ₊₁ is input. The j-th stage STj includes a gate-output terminal OUT1 through which a gate signal Gout(j) is output, and a carry output terminal OUT2 through which the carry signal Cout(j) is output.

However, the first scan-start signal STVP is input to the set terminal S of the first stage ST₁ instead of the carry signal of a previous stage, and the first scan-start signal STVP is input to the reset terminal R of the final stage STₙ₊₁ instead of a gate signal of a next stage.

The j-th stage STⱼ is described hereinafter in further detail with reference to FIGS. 4 and 5.

Referring now to FIG. 4, the j-th stage STⱼ includes a buffer unit 410, a charge unit 420, a pull-up unit 430, a carry signal generator 470, a pull-down unit 440, a discharge unit 450 and a holding unit 460. The j-th stage STⱼ receives the carry signal Cout(j−1) of the previous stage STⱼ₋₁ (see FIG. 5), the clock signal CKV and the clock bar signal CKVB. The clock signal CKV includes first and second maintenance periods PH_1 and PH_2 when the clock signal CKV is maintained at a low level, and the clock signal CKV includes transition periods PT_1 and PT_2 when the clock signal CKV transitions to a high level (e.g., a second level) from a low level (e.g., a first level) and to a low level from a high level. That is, the transition periods PT_1 and PT_2 are defined as a period from a rising edge to a falling edge, as illustrated in FIG. 5.

The buffer unit 410 includes a transistor T4 which is diode-connected. The buffer unit 410 supplies the carry signal Cout(j−1) of the previous stage STⱼ₋₁ to the charge unit 420, the carry signal generator 470 and the pull-up unit 430. The carry signal Cout(j−1) of the previous stage STⱼ₋₁ is input through the set terminal S of the j-th stage STⱼ.

The charge unit 420 includes a capacitor C1 having a first terminal connected to a source terminal of the transistor T4, the pull-up unit 430 and the discharge unit 450, and the capacitor C1 having a second terminal connected to the gate-output terminal OUT1.

The pull-up unit 430 includes a transistor T1 having a drain terminal connected to the first clock terminal CK1, a gate terminal connected to the charge unit 420 and a source terminal connected to the gate-output terminal OUT1.

The carry signal generator 470 includes a transistor T15 having a drain terminal connected to the first clock terminal CK1, a source terminal connected to the carry output terminal OUT2 and a gate terminal connected to the buffer unit 410. The carry signal generator 470 includes a capacitor C2 having a first terminal connected to the gate terminal of the transistor T15 and a second terminal connected to the source terminal of the transistor T15.

The pull-down unit 440 includes a drain terminal connected to the source terminal of the transistor T1 and to the second terminal of the capacitor C1, a source terminal connected to the power supply voltage terminal GV and a gate terminal connected to the reset terminal R.

The discharge unit 450 includes a transistor T9 and a transistor T6. The transistor T9 discharges the charge unit 420 in response to the gate signal Gout(j+1) of the next stage STⱼ₊₁. The transistor T6 discharges the charge unit 420 in response to the initializing signal INT. The transistor T9 includes a gate terminal connected to the reset terminal R, a drain terminal connected to a first terminal of a capacitor C3 and a source terminal connected to the power supply voltage terminal GV.

When the gate signal Gout(j) transitions to the high level (e.g., the second level) from the low level (e.g., the first level), the holding unit 460, which includes a plurality of transistors T3, T5, T7, T8, T10, T11, T12 and T13, holds the gate signal Gout(j) at the high level. When the gate signal Gout(j) transitions to the low level from the high level, the holding unit 460 holds the gate signal Gout(j) at the low level during one frame regardless of the voltage level of the clock signal CKV and clock bar signal CKVB.

The operations of each units described above, are described hereinafter in further detail with reference to FIGS. 4 and 5.

First, a process in which the gate signal Gout(j) transitions to the gate-on voltage Von from the gate-off voltage Voff is now described below.

The charge unit 420 receives the carry signal Cout(j−1) of the previous stage STⱼ₋₁ (see FIG. 5), and the charge unit 420 is thereby charged. That is, during the first maintenance period PH_1, the charge unit 420 receives the carry signal Cout(j−1) of the previous stage STⱼ₋₁ and the charge unit 420 is charged, and a level of the voltage of the node Q_j gradually increases to a first charge level, as illustrated in FIG. 5. However, during the first transition period PT_1, which is the period when the clock signal CKV transitions to the high level, the level of the voltage of the node Q_j further increases to a second charge level due to the transistor T1 and a parasitic capacitor (not shown).

When the voltage of the charge unit 420, that is the voltage of the node Q_j, increases to the first charge level (for example, see FIG. 5), the transistor T1 of the pull-up unit 430 is turned on and supplies the clock signal CKV to the gate-output terminal OUT1. The clock signal CKV is input through the first clock terminal CK1. Here, the gate signal Gout(j) is the clock signal CKV. That is, in exemplary embodiments, the level of the gate signal Gout(j) is the same as the level of the gate-on voltage Von.

Further, the transistor T15 of the carry signal generator 470 is turned on, and the transistor T15 supplies the clock signal CKV to the carry output terminal OUT2. Here, the carry signal Cout(j) is the clock signal CKV.

Next, a process in which the gate signal Gout(j) transitions to the gate-off voltage Voff from the gate-on voltage Von is now described below.

During the first transition period PT_1 when the clock signal CKV transitions to the low level from the high level, the voltage of the node Q_j decreases because of the parasitic capacitor (not shown). Here, when the gate signal Gout(j+1) of the next stage STⱼ₊₁ is at the high level, the transistor of the discharge unit 450 is turned on and supplies the gate-off voltage Voff to the node Q_j. However, the clock bar signal CKVB transitions to the high level from the low level, the transistor T11 of the holding unit 460 is turned on and supplies the carry signal Cout(j−1) of the previous stage STⱼ₋₁ to the node Q_j. The carry signal Cout(j−1) of the previous stage STⱼ₋₁ is a positive voltage. Therefore, even if the discharge unit 450 supplies the gate-off voltage Voff to the node Q_j, the voltage of the node Q_j is not quickly pulled down to the gate-off voltage Voff. Instead, as illustrated in FIG. 5, the voltage of the node Q_j is gradually pulled down to gate-off voltage Voff.

That is, when the gate signal Gout(j+1) of the next stage STⱼ₊₁ is at the high level, the transistor T1 of the pull-up unit 430 is not turned off and supplies the clock signal CKV to the gate signal Gout(j). The clock signal CKV is at the low level. And the pull-down transistor T2 of the pull-down unit 440 is turned on and supplies the gate-off voltage Voff to the gate lines. The level of the gate signal Gout(j) is decreased to the level of the gate-off voltage Voff because the pull-down unit 440 pulls the gate signal Gout(j) down to the gate-off voltage Voff, and the pull-up unit 430 supplies the clock signal CKV, which is at the low level, as the gate signal Gout(j) to the gate-output terminal OUT1. Therefore, the gate signal Gout(j) is not overlapped with the gate signal Gout(j+1) of the next stage STⱼ₊₁.

The operation which holds the gate signal Gout(j) to the gate-off voltage Voff during one frame after the gate signal Gout(j) is decreased to the gate-off voltage Voff is now described in more detail below.

When the gate signal Gout(j) is pulled down to the gate-off voltage Voff, the transistors T8, T13 are turned on. The transistor T13 turns off the transistor T7, such that the transistor T13 may prevent a high level of a clock signal CKV from being applied to the transistor T3, and the transistor T8 turns off the transistor T3. Therefore, in exemplary embodiments, the gate signal Gout(j) is held at the high level.

Next, transistors T8 and T13 are turned off, after the gate signal Gout(j) transitions to the low level from the high level. When the clock signal CKV is at the high level, the transistors T7 and T12 turn on the transistor T3, such that the transistors T7 and T12 hold the gate signal Gout(j) at the low level. Further, the transistor T10 is turned on, so that the gate of the transistor T1 is held at the low level. Therefore, the high level of the first clock signal CKV is not output to the gate-output terminal OUT1.

When the first clock bar signal CKVB is at the high level, and the transistors T5, T11 are turned on. The transistor T5, which is turned on, holds the gate signal Gout(j) at the low level, the transistor T11, which is also turned on, holds one terminal of the capacitor C1 at the low level. Therefore, the gate signal Gout(j) is held at the low level during one frame.

However, in exemplary embodiments, the j-th stage STⱼ may not include the carry signal generator 470. In this case, the j-th stage STⱼ receives the gate signal Gout(j−1) instead of the carry signal Cout(j−1) of the previous stage STⱼ₋₁ through the set terminal S, and may be operated thereby.

The first stage ST₁ is described hereinafter in further detail with reference to FIGS. 6 and 7.

The first stage ST₁ receives the first scan-start signal STVP instead of the carry signal Cout(j−1) of the previous stage STⱼ₋₁. That is, the first stage ST₁ is not the same as other the stages, for example, the first stage ST₁ is not the same as the j-th stage STⱼ. Further, the discharge unit 451 does not include the transistor T9, which is included in the other stages.

The first stage ST₁ is described hereinafter in further detail below.

First, a process in which the gate signal Gout(j) transitions to the gate-on voltage Von from the gate-off voltage Voff is now described below.

The charge unit 420 receives the first scan-start signal STVP (see FIG. 5), and is thereby charged. That is, during the first maintenance period PH_1, the charge unit 420 receives the first scan-start signal STVP and is thereby charged, and the level of the voltage of the node Q_1 gradually increases. During the period when the clock signal CKV, which transitions to the high level, is input during the first transition period PT_1, the level of the voltage of the node Q_1 further increases due to the transistor T1 and a parasitic capacitor (not shown).

When the voltage of the charge unit 420, that is the voltage of the node Q_1, increases to a first charge level (for example, see FIG. 7), the transistor T1 of the pull-up unit 430 is turned on and supplies the clock signal CKV to the gate-output terminal OUT1. The clock signal CKV is input through the first clock terminal CK1, Here, the gate signal Gout(j) is the clock signal CKV. That is, the voltage level of the gate signal Gout(j) is the same voltage level as that of the gate-on voltage Von.

Further, the transistor T15 of the carry signal generator 470 is turned on, and supplies the clock signal CKV to the carry output terminal OUT2. Here, the carry signal Cout(j) is the clock signal CKV.

Next, a process in which the gate signal Gout(j) transitions to the gate-off voltage Voff from the gate-on voltage Von is now described.

During a period when the clock signal CKV transitions to the low level from the high level during the first transition period PT_1, the voltage of the node Q_1 decreases because of the parasitic capacitor (not shown). Here, the clock bar signal CKVB transitions to the high level from the low level, such that the transistor T11 of the holding unit 460 is turned on and supplies the first scan-start signal STVP of the high level to the node Q_1.

After the first transition period PT_1 and before the second transition period PT_2, the first scan-start signal STVP transitions to the low level. That is, after the falling edge of the clock signal CKV of the first transition period PT_1, the first scan signal STVP transitions to the low level during the second maintenance period PH_2. The transistor T11 of the holding unit 460 supplies the first scan-start signal STVP transitioning to the low level to the node Q_1. Therefore, as illustrated in FIG. 7, the voltage of the node Q_1 is maintained at the high level until the falling edge of the first scan-start signal STVP. As a result, the transistor T1 of the pull-up unit 430 is turned on during the first transition period PT_1, and is turned off before the second transition period PT_2, such that the transistor T1 of the pull-up unit 430 outputs the clock signal CKV transitioning at the low level during the first transition PT_1 as the gate signal Gout(1).

Also, when the gate signal Gout(2).of the next stage is at the high level, the transistor T2 of the pull-down unit 440 is turned on and supplies the gate-off voltage Voff to the gate-output terminal OUT1.

The pull-up unit 430 supplies the clock signal CKV of the low level as the gate signal Gout(1), and the pull-down unit 440 decreases the gate signal Gout(1) to the gate-off voltage Voff, such that the level of voltage of the gate signal Gout(j) is rapidly decreased to the gate-off voltage Voff.

As illustrated by dotted lines in FIG. 7, when the first scan-start signal STVP transitions to the low level during the first transition period PT_1, the voltage of the node Q_1 responds to the rising edge of the clock bar signal CKVB, and the voltage of the node Q_1 is decreased to the low level, for example, the voltage of the node Q_1 decreases to the gate-off voltage Voff. Therefore, the transistor T1 of the pull-up unit 430 is turned off and cannot output the clock signal CKV transitioning to the low level during the first transition period PT_1 as the gate signal Gout(1). Also, the pull-down unit 440 only decreases the gate signal Gout(1) to the gate-off voltage Voff, such that the level of voltage of the gate signal Gout(1) is not rapidly decreased to the gate-off voltage Voff, but instead is slowly decreased to the gate-off voltage Voff, as illustrated by the dotted lines in FIG. 7. In this case, the period of the gate signal Gout(1) overlaps with the gate signal Gout(2) of the next stage.

According to an exemplary embodiments of the present invention, the first scan-start signal STVP is maintained at the high level (e.g., a second level) during the first transition period PT_1 of the clock signal CKV, and transitions to the low level (e.g., a first level) before a start of the second transition period PT_2, such that the gate signal Gout(1) does not overlap with the gate signal Gout(2) of the next stage, and thereby improving a display quality. The second transition period PT_2 follows the first transition period PT_1.

The process in which the gate signal Gout(j) is decreased to the gate-off voltage Voff, and maintained at the gate-off voltage Voff during one frame is the same as the process of the j-th stage as described above, and therefore a detailed description thereof will be omitted.

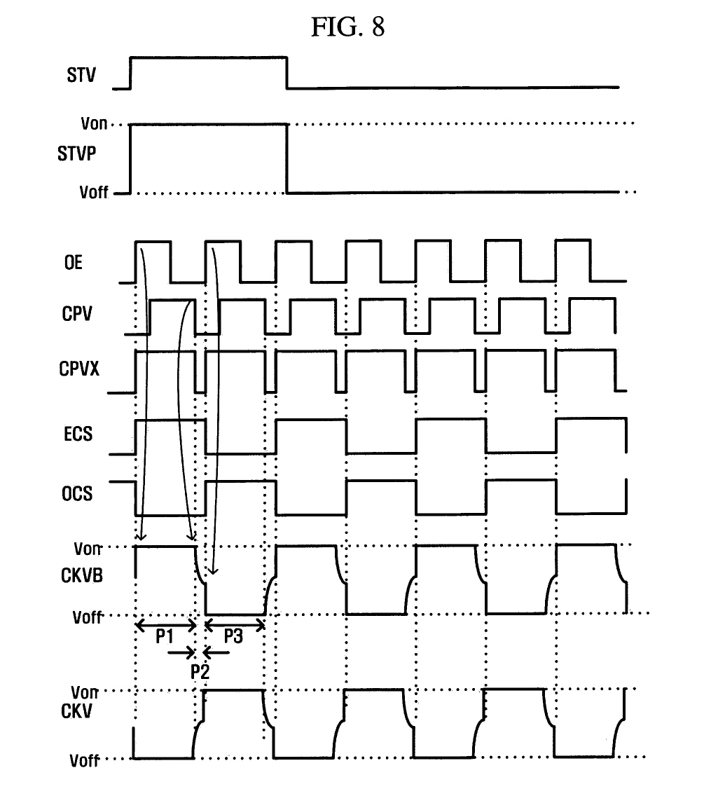

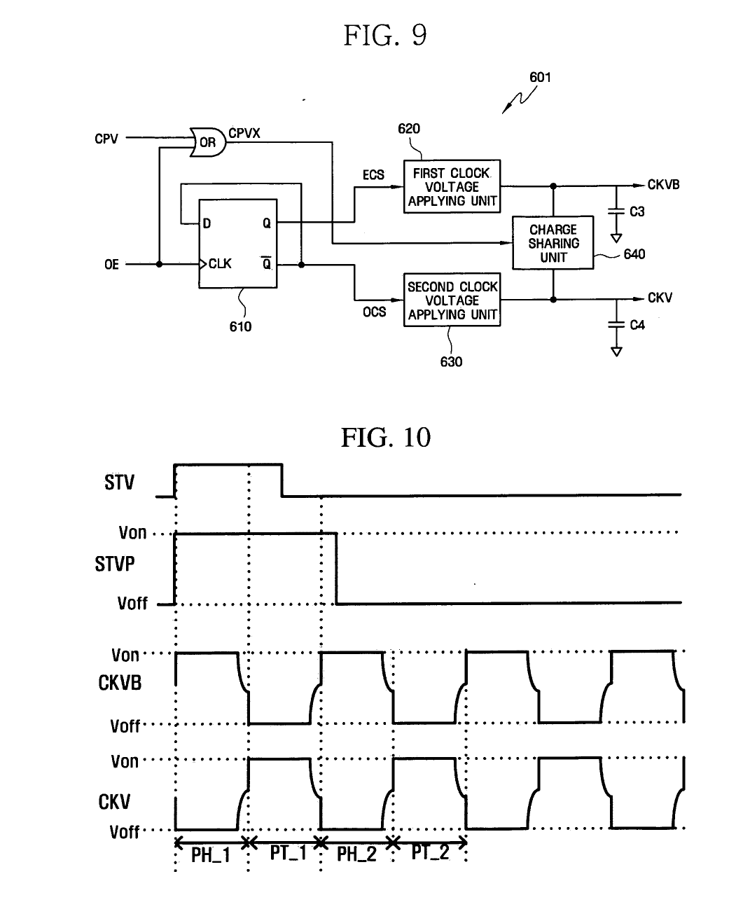

An LCD and a method of driving the same according to a first embodiment of the present invention is described hereinafter in further detail with reference to FIG. 1, FIG. 8 and FIG. 9. FIG. 8 is a signal waveform timing chart for explaining a liquid crystal display and a method of driving the same according to a first embodiment of a first embodiment of the present invention. FIG. 9 is a block diagram for explaining a clock generator of a liquid crystal display according to the first embodiment of the present invention.

Referring to FIG. 1, FIG. 8 and FIG. 9, the timing controller 500 outputs the second scan-start signal STV, the first clock generation control signal OE and the second clock-generation-control signal CPV. Here, a pulse width of the second scan-start signal STVP and a pulse width of the first scan-start signal STVP are the same or substantially similar.

The clock generator 601 includes an amplifier 651. The clock generator 601 may receive the second scan-start signal STV, and amplify the second scan-start signal STV. And the clock generator 601 may output the first scan-start signal STVP. IFor example, the second scan-start signal STV may swing between the gate-on voltage Von and the gate-off voltage Voff.

Further, the clock generator 601 generates the clock signal CKV and the clock bar signal CKVB by using the first clock-generation-control signal OE and the second clock-generation-control signal CPV. The clock signal CKV and the clock bar signal CKVB are toggled on each rising edge of the first clock-generation-control signal OE.

Specifically, the clock generator 601 includes an OR operator OR, D flip-flop 610, the first clock-voltage-applying unit 620, the second clock-voltage-applying unit 630, the charge-sharing unit 640 and capacitors C3 and C4. However, the inner circuit of the clock generator 601 may be not limited to the above.

The D flip-flop 610 outputs the first clock-enable signal ECS through the first output terminal Q, and outputs the second clock-enable signal OCS through the second output terminal Q̅. Specifically, the first clock-generation-control signal OE is input through a clock terminal CLK, and the second output terminal Q̅ is connected to the input terminal D. The first clock-enable signal ECS toggled on each rising edge of the first clock-generation-control signal OE is output through the first output terminal Q, the second clock-enable signal OCS, having a phase reversed to that of the first clock-enable signal ECS, is output through the second output terminal Q̅.

The first clock-enable signal ECS is supplied to the first clock-voltage-applying unit 620, and the second clock-enable signal OCS is supplied to the second clock-voltage-applying unit 630.

The OR operator OR receives the first clock-generation-control signal OE and the second clock-generation-control signal CPV, and the OR operator OR generates the charge-sharing-control signal CPVX. The OR operator OR supplies the charge-sharing-control signal CPVX to the charge-sharing unit 640.

The first clock-voltage-applying unit 620 is enabled by the first clock-enable signal ECS. When the first clock-enable signal ECS is at the high level, the first clock-voltage-applying unit 620 outputs the voltage of the high level Von, and charges the capacitor C3 with the voltage of the low level Voff (see P1 shown in FIG. 8). In the same manner, the second clock-voltage-applying unit 630 is enabled by the second clock-enable signal OCS. When the second clock-enable signal OCS is at the low level, the second clock-voltage-applying unit 630 outputs the voltage of the low level Voff, and charges the capacitor C4 with the voltage of the low level Voff (see P1 shown in FIG. 8). When the second clock-enable signal OCS is at the high level, the second clock-voltage-applying unit 630 outputs the voltage of the high level Von, and charges the capacitor C4 with the voltage of the high level Von (see P3 shown in FIG. 8).

Here, the charge-sharing unit 640 receives the charge-sharing-control signal CPVX. When the capacitors C3 and C4 are charged or discharged, the charge-sharing unit 640 shares the charge.

As described above, when the charge-sharing-control signal CPVX is at a low level, the capacitors C3 and C4 are electrically connected. Therefore the capacitor C3, which is charged with the voltage of the high level Von, begins to discharged. The capacitor C4, which is charged with the voltage of the low level Voff, receives the charge from the capacitor C3, and begins to be charged to the voltage of the high level Von. That is, the capacitors C3 and C4 share the charge in the charge-sharing period P2, as illustrated in FIG. 8. Therefore, the voltage of the capacitor C3 can be easily decreased to the low level Voff in the first low period P3, and the voltage of the capacitor C4 can be easily increased to the high level Von.

According to this process, in the first high period P1, the clock bar signal CKVB is at the high level, and the clock signal CKV is at the low level. In the first low period P3, the first clock signal CKV is at the low level, and the first clock bar signal CKVB is at high level. In the charge-sharing period P2, the clock bar signal CKVB transitions to the low level from the high level, and the clock signal CKV transitions to high level from the low level. However, the clock generator 600 may not include the charge-sharing unit 640.

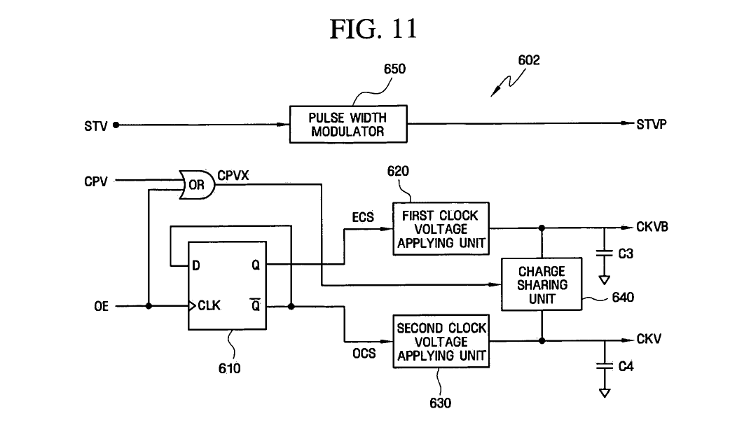

An LCD and a method of driving the same according to a second embodiment of the present invention is described hereinafter in further detail with reference to FIG. 1, FIG. 10 and FIG. 11. FIG. 10 is a signal waveform timing chart for explaining a liquid crystal display and a method of driving the same according to a second embodiment of the present invention. FIG. 11 is a block diagram for explaining a clock generator of a liquid crystal display according to the second embodiment of the present invention.

Referring now to FIG. 1, FIG. 10 and FIG. 11, the LCD according to the second embodiment of the present invention is not the same as the first embodiment as followings. Specifically, Here, the pulse width of the second scan-start signal STV and that of the first scan-start signal STVP are not the same. The clock generator 602 including the pulse width modulator 650 adjusts the pulse width, such that the clock generator 602 outputs the second scan-start signal STVP.

As described above, the timing controller 500 outputs the second scan-start signal STV, the first clock-generation-control signal OE and the second clock-generation-control signal CPV. Here, the pulse width of the second scan-start signal STV is smaller than, for example, the pulse width of the first scan-start signal STVP.

The clock generator 602 includes the pulse width modulator 650. The clock generator 602 adjusts and amplifies the pulse width of the second scan-start signal STV, as illustrated in FIG. 11. The clock generator 602 outputs the first scan-start signal STVP. That is, the pulse width modulator 650 adjusts the pulse width of the second scan-start signal STV, such that the first scan-start signal STVP is at high level during the first transition period PT_1, and the first scan-start signal STVP transitions to the low level before the second transition period PT_2.

As described above, an LCD and a method of driving the same according to the present invention produce an improved display quality.

While the present invention has been particularly shown and described with reference to some exemplary embodiments thereof, it will be understood by those of ordinary skill in the art that various changes in form and detail may be made therein without departing from the spirit and scope of the present invention as defined by the following claims. The exemplary embodiments should be considered in descriptive sense only and not for purposes of limitation.

What is claimed is:

1. A liquid crystal display comprising:
a liquid crystal panel including a plurality of gate lines and a plurality of data lines, which receive a plurality of gate signals and a plurality of data signals, respectively, to display an image;
a gate driver which supplies the plurality of gate signals to the plurality of gate lines; and
a signal supplier which supplies a first scan-start signal, a clock signal and a clock bar signal to the gate driver, the clock bar signal having an inverse phase to that of the clock signal,
wherein the clock signal includes a maintenance period and first and second transition periods, the maintenance period is defined when the clock signal is maintained at a first level, the first and second transition periods are each defined from a point when the clock signal transitions to a second level from the first level and to a subsequent point when the clock signal transitions to the first level from the second level, the first scan-start signal is maintained at the second level during the first transition period.

2. The liquid crystal display of claim 1, wherein the first scan-start signal transitions to the first level from the second level before a start of the second transition period, the second transition period follows the first transition period.

3. The liquid crystal display of claim 1, wherein the clock signal of the first transition period is output to a first gate line among the plurality of gate lines.

4. The liquid crystal display of claim 1, wherein the gate driver includes a plurality of stages which collectively output the plurality of gate signals, and each stage of the plurality of stages includes at least one amorphous silicon thin film transistor formed on the liquid crystal panel.

5. The liquid crystal display of claim 4, wherein a first stage among the plurality of the stages supplies a gate signal to a first gate line among the plurality of gate lines, and the first stage includes a charge unit which receives the first scan-start signal and becomes charged thereby,
a pull-up unit, when enabled, outputs the clock signal as the gate signal when the charge unit is charged to a first charge level, and the pull-up unit is disabled when the charge unit is charged to a second charge level, and
a holding unit which holds the gate signal, the holding unit enabled by the clock bar signal, and the holding unit supplies the first scan-start signal to the charge unit.

6. The liquid crystal display of claim 5, wherein the charge unit receives the first scan-start signal equal to the second level and the charge unit is charged to the first charge level, and
the pull-up unit outputs the clock signal of the first transition period as the gate signal, and
the holding unit supplies the first scan-start signal to the charge unit, wherein the first scan-start signal transitions to the first level from the second level after the clock signal transitions to the first level from the second level, and
the pull-up unit is disabled.

7. The liquid crystal display of claim 4, wherein a first stage among the plurality of the stages supplies a gate signal to a first gate line among the plurality of gate lines, and the first stage includes a capacitor which receives the first scan-start signal and becomes charged thereby,
a pull-up transistor including a gate connected to a first terminal of the capacitor, a drain connected to a second terminal of the capacitor and a source to which the clock signal is applied to, wherein the pull-up transistor includes a first transistor, which outputs the clock signal as the gate signal when the capacitor is charged to a first charge level, and the first transistor is disabled when the charge unit is charged to a second charge level,
a second transistor enabled by a next gate signal of a next stage, and the second transistor decreases a level of voltage of the second terminal of the capacitor, and
the second transistor, when not enabled by the next gate signal of the next stage, decreases a level of voltage of the first terminal of the capacitor.

8. The liquid crystal display of claim 1, wherein the signal supplier includes
a timing controller which supplies the first scan-start signal and a clock-generation-control signal; and
a clock generator which generates the clock signal and the clock bar signal by using the clock-generation-control signal, which is received from the timing controller.

9. The liquid crystal display of claim 8, wherein the clock signal and the clock bar signal are each toggled on each rising edge of the clock-generation-control signal.

10. The liquid crystal display of claim 1, wherein the signal supplier includes a timing controller which supplies a second scan-start signal; and
a clock generator which adjusts a width of a pulse of the second scan-start signal to generate the first scan-start signal.

11. The liquid crystal display of claim 10, wherein the clock generator includes a pulse width modulator which receives the second scan-start signal, and the pulse width modulator outputs the first scan-start signal, which is maintained at the second level during the first transition period.

12. The liquid crystal display of claim 1, wherein the clock signal and the clock bar signal each swing between a gate-on voltage and a gate-off voltage.

13. A method of driving a liquid crystal display, the method comprising:
supplying a first scan-start signal, a clock signal and a clock bar signal to a gate driver, the clock bar signal having an inverse phase to that of the clock signal, a liquid crystal panel including a plurality of gate lines and a plurality of data lines, the gate driver connected to the plurality of gate lines,
wherein the clock signal includes a maintenance period and first and second transition periods, the maintenance period is defined when the clock signal is maintained at a first level, the first and second transition periods are each defined from a point when the clock signal transitions to a second level from the first level and to a subsequent point when the clock signal transitions to the first level from the second level, the first scan-start signal is maintained at the second level during the first transition period;
enabling the gate driver by the first scan-start signal, generating a plurality of gate signals by using the clock signal and the clock bar signal; and
supplying the plurality of gate signals and a plurality of data signals to the plurality of gate lines and the plurality of data lines, respectively, to display an image.

14. The method of claim 13, wherein the first scan-start signal transitions to the first level from the second level before a start of the second transition period, the second transition period follows the first transition period.

15. The method of claim 13, wherein the clock signal of the first transition period is output to a first gate line among the plurality of gate lines.

16. The method of claim 13, wherein the gate driver includes a charge unit receiving a scan-start signal and the charge unit becoming charged thereby,
a pull-up unit, when enabled, outputting the clock signal as a gate signal of the plurality of gate signals when the charge unit is charged to a first charge level, and the pull-up unit is disabled when the charge unit is charged to a second charge level,
a holding unit holding the gate signal, the holding unit enabled by the clock bar signal and supplying the first scan-start signal to the charge unit.

17. The method of claim 16, wherein the supplying of the plurality of gate signals includes:
receiving the scan-start signal equal to the second level and charging the charge unit at the first charge level, and enabling the pull-up unit;
outputting the clock signal of the first transition period as the gate signal;
supplying the scan-start signal to the charge unit, wherein the scan-start signal transitions to the first level from the second level after the clock signal transitions to the first level from the second level; and
disabling the pull-up unit by receiving the scan-start signal of the first level and charging the charge unit to a second charge level.

18. The method of claim 16, wherein the supplying of the scan-start signal includes adjusting a width of a pulse of the scan-start signal to maintain the scan-start signal at the second level during the first transition period.

19. The method of claim 13, wherein the clock signal and the clock bar signal each swing between a gate-on voltage and a gate-off voltage.

20. The method of claim 13, wherein the gate driver includes at least one amorphous silicon thin film transistor formed on the liquid crystal panel.
